(19) United States
(12) Patent Application Publication
(10) Pub. No.: US 2006/0283976 A1
(43) Pub. Date: Dec. 21, 2006

(54) Pop-up sprinkler

(76) Inventor: Anthony M. Wlodarczyk, Yucaipa, CA (US)

Correspondence Address: Anthony M. Wlodarczyk, 13473 Canyon View Drive, Yucaipa, CA, 92399, US

(21) Appl. No.: 11/156,060

(22) Filed: Jun. 17, 2005

(51) Int. Cl. B05B 15/10

(52) U.S. Cl. 239/205

(57) ABSTRACT

The present invention discloses a capless pop-up sprinkler, comprising a housing having an inlet at a lower end thereof, the inlet being connectable to a source of pressurized water; a riser mounted inside the housing for vertical reciprocation through an opening at an upper end of the housing, wherein the upper end of the housing comprises an opening for the riser and provision to accommodate a riser seal without the benefit of a cap; and a nozzle mounted in an upper end of the riser for ejecting a stream of water. Further, the base of the sprinkler can be permanently attached to the housing and comprise an integral quick connection.

### FIELD OF THE INVENTION

The present invention generally relates to a pop-up sprinkler, and more particularly, the present invention relates to a pop-up irrigation sprinkler with the sprinkler base and the sprinkler body connected using a spin weld technique that is configured to create a permanently sealed structure, whereas the sprinkler is without a cap.

### BACKGROUND OF THE INVENTION

Irrigation systems, such as lawn and garden watering systems, are used extensively in the western portion of the United States. The typical watering system consists of a plurality of pop-up sprinklers spaced according to the range of the sprinklers so as to cover the entire lawn area. Individual sprinklers are fed by underground water pipes connected to a water supply source through electrically operated valves and retract during periods of non-watering so as not to be obstructions to the normal daily activities. The sprinklers are typically organized into groups or zones such that several individual sprinklers in a particular area of the lawn are controlled by a single valve, with several separately controlled groups or zones required to cover the entire area. Typically, only one zone is watered at a time to ensure sufficient pressure to operate the sprinklers in the zone.

Pop-up irrigation sprinklers in general are well known in the art. These sprinklers comprise a sprinkler housing including a coupling for attachment to a suitable line source of water under pressure. A pop-up stem or riser is slidably received within the sprinkler housing, and carries a spray head through which water is sprayed for irrigation purposes. In operation, the pop-up riser is springably or gravitationally biased to a retracted position within the housing wherein the uppermost extent of the spray head is positioned substantially flush with the upper extent of the sprinkler housing and the ground. However, when water under pressure is supplied to the sprinkler housing, the pressure urges the riser to slide upwardly within the housing to carry the spray head to an elevated position above the housing. In this elevated position the water under pressure is emitted as a spray through the spray head for supplying irrigation water to a specified area.

U.S. Pat. No. 3,940,066 issued on Feb. 24, 1976, entire contents of which are incorporated herein by reference, discloses a pressure control mechanism for an irrigation sprinkler having a rotatable riser with an orifice of predetermined shape with the riser sealed at the water inlet end thereof, wherein a stationary valve ring is snug-fit around the riser and circumferentially stationary with respect to the riser.

U.S. Pat. No. 3,957,205 issued on May 18, 1976, entire contents of which are incorporated herein by reference, discloses a sprinkler having a sprinkler head fixed to a tubular spindle which is rotatably journaled in and spring biased upwardly relative to a bearing sleeve, and an upper and lower seals for sealing the clearance space between the spindle and bearing sleeve against entrance of water, dirt, grit, and the like.

U.S. Pat. No. 4,073,438 issued on Feb. 14, 1978, entire contents of which are incorporated herein by reference, discloses a sprinkler head comprising a stationary sprinkler body structure defining an inlet and a water-tight chamber communicating with the inlet, a movable tubular water distributing structure providing an inlet and a spaced discharge nozzle in flow communication relation therewith for water orbital movement.

U.S. Pat. No. 4,350,300 issued on Sep. 21, 1982, entire contents of which are incorporated herein by reference, discloses a spray head device including an enclosed housing adapted for connection to a source of water, and which houses water jet apparatus constructed to issue a jet of water and sized for a predetermined range of volume flow. A frame connected to the housing suspends a diffuser element in a position where it is impinged by the jet of water to disperse the water into a flow pattern of predetermined configuration.

U.S. Pat. No. 4,351,477 issued on Sep. 28, 1982, entire contents of which are incorporated herein by reference, discloses a pop-up sprinkler has a sprinkler housing containing a pop-up spray nozzle assembly springably biased to a retracted position. A clamping collar prevents rotation of the elevated spray nozzle assembly with respect to the housing.

U.S. Pat. No. 5,028,005 issued on Jul. 2, 1991, entire contents of which are incorporated herein by reference, discloses a cylinder and piston assembly for a retracting sprinkler head that is buried well below ground surface of an area to be irrigated. The piston has an elongated, tubular sprinkler riser pipe extending upwardly from an upright cylinder whereas the piston and the riser pipe are forced upwardly by water under pressure supplied to the cylinder through the lower water port.

U.S. Pat. No. 5,938,121 issued on Aug. 17, 1999, entire contents of which are incorporated herein by reference, discloses a pop-up sprinkler housing having a cap sleeve that slides adjustably into a base sleeve having a base plate with a fluid conveyance that screws onto underground sprinkler plumbing and into sprinkler shafts. A housing cap on top of the cap sleeve has a sprinkler-shaft aperture that is sized and shaped to allow ingress and egress of pop-up portions of select sprinkler shafts and has cap-sleeve shoulders that extend over the base sleeve and a support surface.

U.S. Pat. No. 6,478,237 issued on Nov. 12, 2002, entire contents of which are incorporated herein by reference, discloses a dirt-resistant bearing system for a sprinkler unit with a rotatable turret having a central shaft extending into a support channel formed within an inner housing. The invention further discloses a sprinkler head with a fitted serrated seal assembly, wherein the fitted seal assembly may include an outer case having an interior region, and a pop-up sprinkler head turret mounted on a riser sleeve slidably mounted within the interior region of the outer case.

U.S. Pat. No. 6,488,218 issued on Dec. 3, 2002, entire contents of which are incorporated herein by reference, discloses a pop-up sprinkler assembly including a cylindrical housing having a cap on an upper end thereof, the cap having an opening, a lower end of the cylindrical housing having an internal thread for attachment to a source of pressurized water. A stem is mounted in the cylindrical housing with a spring radially between the stem and the cylindrical housing for normally biasing the stem to a retracted position within the cylindrical housing.

U.S. Pat. No. 6,491,235 issued on Dec. 10, 2002, entire contents of which are incorporated herein by reference, discloses a top serviceable pop-up sprinkler including a main cylindrical outer housing having a female threaded inlet at a lower end thereof. A spring biased tubular riser is mounted inside the outer housing for vertical reciprocation through an opening in an upper end of the outer housing. A nozzle is fixed in a nozzle head rotatably mounted at an upper end of the riser for ejecting a stream of water. The nozzle is rotated over an adjustable arc by a conventional turbine, gear drive and arc adjustable reversing mechanism.

U.S. Pat. No. 6,530,531 issued on Mar. 11, 2003, entire contents of which are incorporated herein by reference, discloses a pop-up sprinkler including a riser that moves upwardly out of a sprinkler housing when water pressure is applied and that allows manual adjustment of the angular orientation of the riser with respect to the housing to adjust angular orientation of the spray from the sprinkler, and provides for such angular adjustment by having a toothed flange associated with the riser in the housing which engages tabs associated with the housing.

None of the prior art discloses an irrigation pop-up sprinkler without a cap. Furthermore, none of the prior art discloses that the sprinkler base and the sprinkler body are connected using a spin weld configured to create a permanently sealed structure. Still furthermore, none of the prior art discloses a sprinkler with the sprinkler base that ends with a quick connection flexible pipe fitting that does not require an extra fitting to connect the sprinkler to the main water line.

In accordance with the present invention there is provided a sprinkler apparatus having unique features of a base and its sprinkler body connected using a spin weld or other appropriate process creating a permanently sealed structure that is designed and configured for trouble-free use in irrigation applications.

### SUMMARY OF THE INVENTION

In general, it is one object of the present invention to provide a sprinkler with the sprinkler base and the sprinkler body connected using a spin weld or other appropriate process that is configured to create a permanently sealed structure.

It is another object of the present invention to provide a sprinkler with the sprinkler base which ends with a quick connection pipe fitting that does not require an extra fitting to connect the sprinkler to the main line. In one embodiment, the flexibility of the quick connection, such as a funny pipe fitting, prevents the sprinkler from breaking.

It is also another object of the present invention to provide a retractable sprinkler, wherein the sprinkler unit does not have a cap. A sprinkler without a cap still can be serviced by unclogging the filter screen and spray nozzle.

Some aspects of the invention relate to a capless pop-up sprinkler, comprising: a housing having an inlet at a lower end thereof, the inlet being connectable to a source of pressurized water; a riser mounted inside the housing for vertical reciprocation through an opening at an upper end of the housing, wherein the upper end of the housing is an integral part of the housing without a cap; and a nozzle mounted in an upper end of the riser for ejecting a stream of the water.

Some aspects of the invention relate to a pop-up sprinkler system, comprising: a housing having an inlet at a lower end thereof, the inlet being connectable to a source of pressurized water; a riser mounted inside the housing for vertical reciprocation through an opening at an upper end of the housing; a nozzle mounted in an upper end of the riser for ejecting a stream of the water; and a sprinkler base joined or connected to the inlet of the housing, the base having an inlet portion and an outlet portion, wherein the joint or connection between the outlet portion of the base and the inlet of the housing is configured to create a sealed structure. In one embodiment, the sealed structure is a permanently sealed structure.

Some aspects of the invention relate to a pop-up sprinkler system, comprising: a housing having an inlet at a lower end thereof, the inlet being connectable to a source of pressurized water; a riser mounted inside the housing for vertical reciprocation through an opening at an upper end of the housing; a nozzle mounted in an upper end of the riser for ejecting a stream of the water; and a sprinkler base joined or connected to the inlet of the housing, the base having an inlet end and an outlet end, wherein the inlet end of the base is configured with a quick connection pipe fitting that does not require an extra fitting or clamp to connect the base to a main water line.

### BRIEF DESCRIPTION OF THE DRAWINGS

Additional objects and features of the present invention will become more apparent and the invention itself will be best understood from the following Detailed Description of Exemplary Embodiments, when read with reference to the accompanying drawings.

FIG. 1 shows a perspective view of the pop-up sprinkler according to the principles of the present invention.

FIG. 2 shows a cross-sectional illustration of the sprinkler of FIG. 1.

FIG. 3 shows a cross-sectional view of the pre-assembled pop-up sprinkler.

### DETAILED DESCRIPTION OF EXEMPLARY EMBODIMENTS

The following detailed description is of the best presently contemplated modes of carrying out the invention. This description is not to be taken in a limiting sense, but is made merely for the purposes of illustrating general principles of embodiments of the invention.

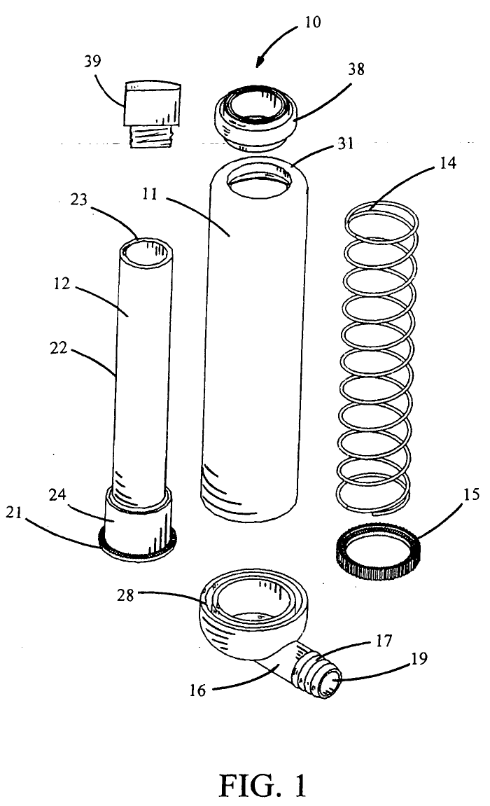

Referring to FIGS. 1-3, a pop-up irrigation sprinkler 10 according to the invention comprises a generally tubular sprinkler housing or body 11 having a water inlet passage and an internal wall defining an elongated upright bore 27 connected to the inlet passage 29. The sprinkler further comprises a riser 12 having an upper end 23 and a lower end 34, and a flow passage extending between the ends, the upper end being adapted to receive and engage a sprinkler nozzle 39, the riser being fitted in the housing bore 27 to be movable between an extended and retracted positions. A coil spring means 14 is provided within the housing bore for urging the riser into the retracted position. The body has a shaped (for example, circular) lower end 35 that inserts into a matching groove 28 of the base 16 for secured water-tight sealing.

The main body 11 of the sprinkler 10 above the lower end 35 is formed as a hollow tube which extends upwardly to an upper end 36. The upper end 36 subassembly comprises an annular restricted flange 31 having a diameter smaller than the diameter of the annular retainer 37 of the riser. The upper end, including the annular restricted flange, is an integral part or co-extension of the sprinkler body 11 without a cap. Prior art sprinkler always comprises a removable sprinkler cap, such as a snug-fit cap, a threaded cap, a removable cap, or the like. The “sprinkler cap” is meant herein to indicate a removable cap that can be removed for servicing the sprinkler body. The cap has several disadvantages. The cap needs to be sealed; in most cases, the cap needs to be removably sealed so it can be opened when desired. The cap is a source of lower structural integrity. The cap requires a larger diameter to erupt at the surface of the lawn. And the cap requires one more piece to complete the system. In one embodiment, the number of the separable parts for the sprinkler of the invention can be as small as seven, including a sprinkler body, a riser, a nozzle, a seal, a spring, a ratchet ring, and a base. In one embodiment, the inner surface space of the upper end 36 is generally cylindrical. The inner surface of the sprinkler housing defines a generally cylindrical bore 27.

In some applications, the sprinkler housing subassembly includes a vertically oriented coupling for connection to the water line source. In other applications, some pop-up sprinklers include a housing subassembly with a horizontally oriented coupling for connection to a line source of water.

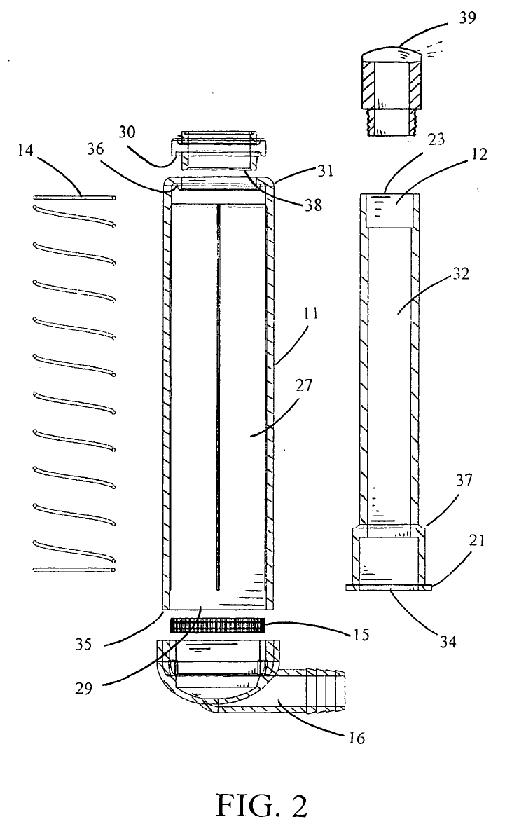

In one embodiment, the funny pipe coupling to be incorporated in the present invention is capable of providing a flexible connection to the lateral piping system. In another embodiment, the sprinkler base fitting is made to connect directly to a thick walled flexible tubing/piping that is readily available. The flexibility allows for easy sprinkler installation especially with pop-up models, while minimizing damage to sprinklers and piping from impact. The sprinkler base fitting has an external barb type protrusion 17 capable of retaining a flexible pipe without the use of clamps. The fitting can be injection molded from ABS, which is available in high impact resistant grades. The flexibility of the sprinkler base which ends with a quick connection pipe fitting that does not require an extra fitting to connect the sprinkler to the main line. In one embodiment, the flexibility of the quick connection prevents the sprinkler from breaking. By way of illustration, if one accidentally steps on it, the flexible pipe will flex, preventing a broken sprinkler connection at the main water distribution line connection. A flexible pipe fitting coupling is applied and fitted into the inlet base 16 as shown in FIGS. 1 and 2.

A hollow tubular riser 12 makes a loose slip fit within the bore 27 of the sprinkler housing 11 to define an annular space or annulus between the outer surface 22 of the riser and the inner surface of the housing. A central and generally cylindrical bore 32 extends between the ends 23, 34 of the riser. The riser has a land 37 at the lower half of the riser for sealing against the bottom of the seal 38 when the riser is uplifted by the incoming water against the seal. The seal 38 is contained within the upper portion of the housing against the upper end 36 of the housing.

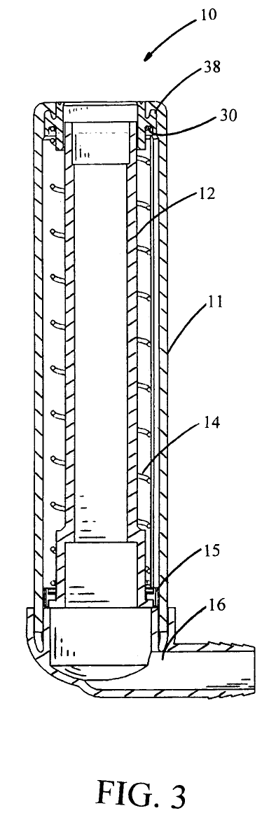

A compression coil spring 14 fits loosely over the cylindrical part of the riser and the spring has close-wound upper and lower ends, and spaced-apart turns between these ends. The upper end of the spring abuts the seal groove 30 (shown in FIG. 3). The seal 38 in turn abuts the inner shoulder of the upper end 36 of the housing and the bottom of the spring seats on the ratchet ring 15 which in turn seats at the lower end 21 of the riser. The spring is thus captive within the housing bore, but it permits upward movement of the riser until the spring is appropriately compressed within the section 24 of the riser.

The cylindrical base 16 has an inlet port 19 into which fluid is transmitted. In the passive state, the spring 14 abuts against the seal 38 which in turn abuts against shoulder of the upper end 36 of the housing to urge the riser 12 downwardly to be completely surrounded circumferentially by the housing 11. Fluid pressure transmitted from the inlet port 19 urges the riser 12 upwardly against the bias of spring 14 until land 37 seals against bottom of the seal 38. The fluid is transmitted through the riser 12 and out of the riser end 23, through a screen (not shown) and nozzle 39. The nozzle is connected to the upper end section 23 of the riser through threaded coupling or other connecting means. The nozzle at the discharge end of the riser controls the area of coverage of the fluid discharged from the riser. As shown in U.S. Pat. No. 3,940,066, entire contents of which are incorporated herein by reference, a nozzle and/or a filter screen on a riser of a sprinkler is well known to one ordinary skilled in the art.

In one embodiment, the riser 12 of the sprinkler 10 incorporates a ratchet mechanism 15 that normally fixes the rotational position of the riser 10 within the housing 1 1 but permits the riser to be rotated relative to the housing to orient the selected arc over the desired area of coverage. The ratchet mechanism is generally in the form of a plurality of circumferentially spaced rounded projections or teeth on the ring thereof. In one embodiment, the lower inlet section of the housing 11 is sized, designed, configured, and manufactured for securing the sprinkler housing onto the base to create a permanently sealed structure. In one embodiment, the secure method comprises a spin welding process. In another embodiment, the secure method comprises a bonding process. In general, the pop-up sprinkler of the invention is designed to be manufactured in a simple, easy, and inexpensive manner. The dimensions and material of manufacture for the sprinkler are generally within the scope of industrial standards.

Some aspects of the invention relate to a capless pop-up sprinkler, comprising: a housing having an inlet at a lower end thereof, the inlet being connectable to a source of pressurized water; a riser mounted inside the housing for vertical reciprocation through an opening at an upper end of the housing, wherein the upper end of the housing is an integral part of the housing without a cap; and a nozzle mounted in an upper end of the riser for ejecting a stream of the water.

Some aspects of the invention relate to a pop-up sprinkler system, comprising: a housing having an inlet at a lower end thereof, the inlet being connectable to a source of pressurized water; a riser mounted inside the housing for vertical reciprocation through an opening at an upper end of the housing; a nozzle mounted in an upper end of the riser for ejecting a stream of the water; and a sprinkler base joined to or connected to the inlet of the housing, the base having an inlet portion and an outlet portion, wherein the joint between the outlet portion of the base and the inlet of the housing is configured to create a sealed structure. In one embodiment, the sealed structure is a permanently sealed structure. The process for joining the base to the housing can be accomplished by a welding process with heat or by a bonding process without heat. Examples for a welding process include spin welding, sonic welding, friction welding, laser welding, and the like. Examples for a bonding process include gluing, adhesive bonding, solvent bonding, and the like.

From the foregoing description, it should now be appreciated that a novel and unobvious irrigation sprinkler system has been disclosed for a variety of applications. While the invention has been described with reference to a specific embodiment, the description is illustrative of the invention and is not to be construed as limiting the invention. Various modifications and applications may occur to those who are skilled in the art, without departing from the true spirit and scope of the invention.

What is claimed is:

1. A capless pop-up sprinkler, comprising:
a housing having an inlet at a lower end thereof, said inlet being connectable to a source of pressurized water;
a riser mounted inside the housing for vertical reciprocation through an opening at an upper end of the housing, wherein said upper end of the housing is an integral part of the housing and has no cap; and
a nozzle mounted in an upper end of the riser for ejecting a stream of said water.

2. The capless sprinkler of claim 1, wherein the riser comprises at least one filter screen.

3. The capless sprinkler of claim 1, further comprising a sprinkler base joined to the inlet of the housing, said base having an inlet portion and an outlet portion, wherein a joint between the outlet portion of the base and the inlet of the housing is configured to create a sealed structure.

4. The capless sprinkler of claim 3, wherein said sealed structure is a permanently sealed structure.

5. The capless sprinkler of claim 3, wherein said inlet portion of the base is configured with a quick connection pipe fitting that does not require an extra fitting to connect the base to a main water line.

6. The capless sprinkler of claim 5, wherein the quick connection pipe fitting is a funny pipe fitting.

7. The capless sprinkler of claim 5, wherein an outer surface of the inlet portion of the base comprises a barb type protrusion capable of retaining a flexible pipe without use of clamps.

8. A pop-up sprinkler system, comprising:
a housing having an inlet at a lower end thereof, said inlet being connectable to a source of pressurized water;
a riser mounted inside the housing for vertical reciprocation through an opening at an upper end of the housing;
a nozzle mounted in an upper end of the riser for ejecting a stream of said water; and
a sprinkler base joined to the inlet of the housing, said base having an inlet portion and an outlet portion, wherein a joint between the outlet portion of the base and the inlet of the housing is configured to create a sealed structure.

9. The pop-up sprinkler system of claim 8, wherein said sealed structure is a permanently sealed structure.

10. The pop-up sprinkler system of claim 8, wherein a process for joining the outlet portion of the base to the inlet of the housing uses a spin welding process.

11. The pop-up sprinkler system of claim 8, wherein a process for joining the outlet portion of the base to the inlet of the housing uses a laser welding process.

12. The pop-up sprinkler system of claim 8, wherein a process for joining the outlet portion of the base to the inlet of the housing uses a sonic welding process.

13. The pop-up sprinkler system of claim 8, wherein a process for joining the outlet portion of the base to the inlet of the housing uses a solvent bonding process.

14. The pop-up sprinkler system of claim 8, wherein a process for joining the outlet portion of the base to the inlet of the housing uses a glue or adhesive bonding process.

15. The pop-up sprinkler system of claim 8, wherein the riser further comprises at least one filter screen.

16. A pop-up sprinkler system, comprising:
a housing having an inlet at a lower end thereof, said inlet being connectable to a source of pressurized water;
a riser mounted inside the housing for vertical reciprocation through an opening at an upper end of the housing;
a nozzle mounted in an upper end of the riser for ejecting a stream of said water; and
a sprinkler base joined to the inlet of the housing, said base having an inlet end and an outlet end, wherein said inlet end of the base is configured with a quick connection pipe fitting that does not require an extra fitting to connect the base to a main water line.

17. The pop-up sprinkler system of claim 16, wherein the quick connection pipe fitting is a funny pipe fitting.

18. The pop-up sprinkler system of claim 16, wherein a joint between the outlet portion of the base and the inlet of the housing is configured to create a sealed structure.

19. The pop-up sprinkler system of claim 18, wherein the sealed structure is a permanently sealed structure.

20. The pop-up sprinkler system of claim 16, wherein the riser further comprises at least one filter screen.
